(19) United States
(12) Patent Application Publication
(10) Pub. No.: US 2025/0246367 A1
(43) Pub. Date: Jul. 31, 2025

(54) TREATMENT METHOD FOR ENHANCING COERCIVE FORCE OF NEODYMIUM IRON BORON MAGNET

(71) Applicant: China Jiliang University, Hangzhou (CN)

(72) Inventors: Qiong WU, Hangzhou (CN); Jiahui YAN, Hangzhou (CN); Hangfu YANG, Hangzhou (CN); Xiukun HU, Hangzhou (CN); Minxiang PAN, Hangzhou (CN); Nengjun YU, Hangzhou (CN)

(73) Assignee: China Jiliang University, Hangzhou (CN)

(21) Appl. No.: 18/424,885

(22) Filed: Jan. 29, 2024

(30) Foreign Application Priority Data
Dec. 8, 2022 (CN) 202211572075.8

(51) Int. Cl. H01F 41/02; H01F 1/057

(52) U.S. Cl. CPC H01F 41/0293; H01F 1/0577

(57) ABSTRACT

A treatment method for enhancing coercive force of neodymium iron boron magnet includes the following steps: subjecting the neodymium iron boron magnet to electrochemical deposition in a diffusion water-based solution to obtain a neodymium iron boron magnet containing a heavy rare earth; and subjecting the neodymium iron boron magnet containing the heavy rare earth to heat treatment to complete enhancement of the coercive force of the neodymium iron boron magnet. The raw material used in the present invention is cheap heavy rare earth compounds which increases the selection of diffusion sources and lowers costs. Metal alloy particles are mainly obtained in a nanoscale size and can effectively enter crystal grains, and low-melting-point metal alloy components can enhance a demagnetizing coupling effect between main phase grains. According to the present invention, the coercive force of the magnet is increased by nearly 30%, and residual magnetism is almost not changed.

### CROSS REFERENCE TO THE RELATED APPLICATIONS

This application is based upon and claims priority to Chinese Patent Application No. 202211572075.8, filed on Feb. 8, 2022, the entire contents of which are incorporated herein by reference.

### TECHNICAL FIELD

The present invention relates to the technical field of magnetic materials, in particular to a treatment method for enhancing a coercive force of a neodymium iron boron magnet.

### BACKGROUND

As third-generation magnetic materials, neodymium iron boron magnets are known as the “king of magnets” due to excellent magnetic properties under room temperature working conditions, which have been widely used in aerospace, instruments and apparatuses, electrocommunication, medical treatment and health care, new energy and other high-end fields. Currently developed sintered neodymium iron boron magnets have great differences between coercive forces and theoretical values, and temperature stability is also a main factor restricting the extension and expansion of the application field of the sintered neodymium iron boron magnets. Although the coercive forces of magnets can be improved by a traditional method of doping heavy rare earth elements, rare earth resources are greatly consumed, and rapid deterioration of residual magnetism of the magnets is likely to be caused. In recent years, neodymium iron boron permanent magnet materials have been continuously developed by researchers, and a grain boundary diffusion process is obtained. That is to say, by adding small amounts of heavy rare earth elements into a magnet, the coercive force of a material is greatly improved, and meanwhile, residual magnetism is almost not affected.

At present, a research hotspot at home and abroad is that a heavy rare earth Dy or Tb enters crystal grains through a grain boundary diffusion source to react with neodymium iron boron main phase grains to produce (Dy,Nd)₂Fe₁₄B/(Tb,Nd)₂Fe₁₄B, so as to improve the coercive force of a neodymium iron boron magnet. In addition, since the content of the added heavy rare earth element is small, almost no impact is caused to the residual magnetism of the magnet. However, a sputtering method, a coating method and a strip adhesion method widely used at present have the disadvantages that the use amounts of heavy rare earth elements are still large, the utilization rate is extremely low, requirements for process production equipment are high, and the production cost is high and not reduced due to expensive heavy rare earth elements. Therefore, it is urgent to find a new neodymium iron boron grain boundary diffusion process.

### SUMMARY

The purposes of the present invention are to solve the problems of the prior art and provide a treatment method for enhancing the coercive force of a neodymium iron boron magnet.

In order to achieve the above purposes, the present invention provides the following technical schemes.

The present invention provides a treatment method for enhancing the coercive force of a neodymium iron boron magnet. The treatment method comprises the following steps:
(1) subjecting the neodymium iron boron magnet to electrochemical deposition in a diffusion water-based solution to obtain a neodymium iron boron magnet containing heavy rare earth; and
(2) subjecting the neodymium iron boron magnet containing heavy rare earth to heat treatment to complete enhancement of the coercive force of the neodymium iron boron magnet.

As a preference, the diffusion water-based solution in step (1) comprises the following components: a chloride salt of heavy rare earth, copper sulfate pentahydrate, aluminum chloride, boric acid, glycine, citric acid, sodium citrate, sodium sulfate and water;
the chloride salt of heavy rare earth is dysprosium chloride hexahydrate or terbium trichloride hexahydrate;
the molar ratio of the chloride salt of heavy rare earth, the copper sulfate pentahydrate, the aluminum chloride, the boric acid, the glycine, the citric acid, the sodium citrate and the sodium sulfate is (0.5-1.5):(0.5-1.5):(0.5-1.5):(2.5-3.5):(2.5-3.5):(3.5-4.5):(3.5-4.5):(2.5-3.5); and the molar concentration of the heavy rare earth element in the diffusion water-based solution is 4-6%.

As a preference, the diffusion water-based solution in step (1) has a pH value of 5-6; and the electrochemical deposition is at a current of 5-10 mA.

As a preference, the electrochemical deposition in step (1) is performed at a solution temperature of 45-55° C.

As a preference, the electrochemical deposition in step (1) is performed for 10-30 min.

As a preference, the heat treatment in step (2) comprises first-stage diffusion heat treatment and second-stage tempering heat treatment that are performed sequentially;
the first-stage diffusion heat treatment is at a first-stage vacuum degree of 0.55-0.60 Pa and a second-stage vacuum degree of 1×10⁻⁵-1×10⁻⁴ Pa;
and the second-stage tempering heat treatment is performed at a first-stage vacuum degree of 0.55-0.60 Pa and a second-stage vacuum degree of 1×10⁻⁵-1×10⁻⁴ Pa.

As a preference, the first-stage diffusion heat treatment is performed at a temperature of 500-950° C., and the first-stage diffusion heat treatment is performed for 1-8 h.

As a preference, the second-stage tempering heat treatment is performed at a temperature of 400-550° C., and the second-stage tempering heat treatment is performed for 1-2 h.

The present invention has the following beneficial effects.
(1) A water-based heavy rare earth solution is used as a diffusion source in the present invention, and compared with diffusion sources selected in other grain boundary diffusion processes, original expensive heavy rare earth metal elementary substances or heavy rare earth hydrides are replaced with other cheaper heavy rare earth compounds, so that the selection of diffusion sources is greatly increased, and the production cost is reduced.
(2) Electrochemical deposition is used as a processing technology in the present invention, and compared with other grain boundary diffusion processes, has the advantages that the process cost is lower, the process flow is simple and easy to operate, the safety performance is excellent, no requirements for production equipment are needed, an obtained coating layer is uniform, the diffusion source can be effectively deposited on an outer surface of a plated part in any shape, and the adaptation range of a neodymium iron boron deposited part substrate is greatly widened.
(3) Metal alloy particles obtained through deposition in the present invention are mainly in a nanoscale particle size and can more effectively enter crystal grains to be wrapped around a neodymium iron boron main phase when being molten into a liquid state or sublimated into a gas state, and low-melting-point metal alloy components (copper sulfate pentahydrate and aluminum chloride) can wet a grain boundary phase to enhance a demagnetizing coupling effect between main phase grains, so that a magnet structure is optimized, and magnetic properties of the magnet are improved.
(4) After the grain boundary diffusion heat treatment of the present invention is performed, the coercive force of the magnet is effectively improved, and the residual magnetism of the magnet is almost not reduced. Tests have found that the coercive force of the magnet after diffusion is effectively increased by nearly 30%.

### DETAILED DESCRIPTION OF THE EMBODIMENTS

The present invention provides a treatment method for enhancing the coercive force of a neodymium iron boron magnet. The treatment method comprises the following steps:
(1) subjecting the neodymium iron boron magnet to electrochemical deposition in a diffusion water-based solution to obtain a neodymium iron boron magnet containing heavy rare earth;
(2) subjecting the neodymium iron boron magnet containing heavy rare earth to heat treatment to complete enhancement of the coercive force of the neodymium iron boron magnet.

In the present invention, the diffusion water-based solution in step (1) preferably comprises the following components: a chloride salt of heavy rare earth, copper sulfate pentahydrate, aluminum chloride, boric acid, glycine, citric acid, sodium citrate, sodium sulfate and water;
the chloride salt of heavy rare earth is preferably dysprosium chloride hexahydrate or terbium trichloride hexahydrate;
the molar ratio of the chloride salt of heavy rare earth, the copper sulfate pentahydrate, the aluminum chloride, the boric acid, the glycine, the citric acid, the sodium citrate and the sodium sulfate is preferably (0.5-1.5):(0.5-1.5):(0.5-1.5):(2.5-3.5):(2.5-3.5):(3.5-4.5):(3.5-4.5):(2.5-3.5), further preferably (0.6-1.4):(0.6-1.4):(0.6-1.4):(2.6-3.4):(2.6-3.4):(3.6-4.4):(3.6-4.4):(2.6-3.4), and more preferably (0.8-1.2):(0.8-1.2):(0.8-1.2):(2.8-3.2):(2.8-3.2):(3.8-4.2):(3.8-4.2):(2.8-3.2); and the molar concentration of the heavy rare earth element in the diffusion water-based solution is preferably 4-6%, further preferably 4.5-5.5%, and more preferably 4.8-5.2%.

In the present invention, the chloride salt of heavy rare earth, the copper sulfate pentahydrate and the aluminum chloride are used as main salts to participate in a reaction, the glycine and the boric acid are used as buffer stabilizers, the citric acid is used as a complexing agent, and the sodium citrate and the sodium sulfate are added to enhance the conductivity of the solution.

In the present invention, various components are subjected to full mixing and dissolution by a constant-temperature magnetic stirrer to obtain a sapphire clear and transparent diffusion water-based solution, and the stirring temperature of the mixing is preferably 45-55° C., further preferably 47-53° C., and more preferably 49-51° C.; the stirring rotation speed of the mixing is preferably 200-250 r/min, further preferably 210-240 r/min, and more preferably 220-230 r/min; and the stirring time of the mixing is preferably 20-30 min, further preferably 22-28 min, and more preferably 24-26 min.

In the present invention, the diffusion water-based solution obtained after mixing is highly acidic, and the pH value of the diffusion water-based solution needs to be adjusted with a NaOH solution to make components of a plating solution more stable. The molar concentration of the NaOH solution is preferably 0.8-1.2 mol/L, further preferably 0.9-1.1 mol/L, and more preferably 0.95-1.05 mol/L; and the pH value is preferably 5-6, further preferably 5.2-5.8, and more preferably 5.4-5.6.

In the present invention, the electrochemical deposition in step (1) is performed by an electrochemical workstation using a three-electrode working system, and the diffusion water-based solution is co-deposited by a constant-current deposition method; a pure copper sheet attached with a neodymium iron boron magnet is used as a working electrode of the electrochemical deposition, and a metal platinum sheet electrode is used as a counter electrode.

In the present invention, the neodymium iron boron magnet is purchased, and the neodymium iron boron magnet is preferably subjected to polishing before use; the polishing comprises first polishing, second polishing and third polishing that are performed sequentially; the mesh number of the first polishing is preferably 700-900 mesh, further preferably 750-850 mesh, and more preferably 780-820 mesh; the mesh number of the second polishing is preferably 1,400-1,600 mesh, further preferably 1,450-1,550 mesh, and more preferably 1,480-1,520 mesh; and the mesh number of the third polishing is preferably 2,900-3,100 mesh, further preferably 2,950-3,050 mesh, and more preferably 2,980-3,020 mesh.

In the present invention, after completion of the polishing, the surface of the neodymium iron boron magnet is bright and smooth, and the polished neodymium iron boron magnet is adhered to the surface of the pure copper sheet without an oxide layer by a conductive copper adhesive that can conduct electricity on both sides to serve as a working electrode phase of the electrochemical deposition.

In the present invention, the current of the electrochemical deposition in step (1) is preferably 5-10 mA, further preferably 6-9 mA, and more preferably 7-8 mA.

In the present invention, the solution temperature of the electrochemical deposition in step (1) is preferably 45-55° C., further preferably 47-53° C., and more preferably 49-51° C.

In the present invention, the time of the electrochemical deposition in step (1) is preferably 10-30 min, further preferably 15-25 min, and more preferably 18-22 min.

In the present invention, after completion of the electrochemical deposition, the neodymium iron boron magnet containing the heavy rare earth is sequentially subjected to first rinsing, second rinsing and drying, followed by subsequent heat treatment.

In the present invention, water is used as a reagent for the first rinsing, anhydrous ethanol is used as a reagent for the second rinsing, and the vacuum degree of the drying is preferably 0.10-0.50 Pa, further preferably 0.20-0.40 Pa, and more preferably 0.25-0.35 Pa; the drying temperature is preferably 40-50° C., further preferably 42-48° C., and more preferably 44-46° C.; and the drying time is preferably 45-60 min, further preferably 50-55 min, and more preferably 52-53 min.

In the present invention, the heat treatment in step (2) comprises first-stage diffusion heat treatment and second-stage tempering heat treatment that are performed sequentially.

In the present invention, the heat treatment in step (2) is performed in an annealing furnace equipped with vacuum equipment, the annealing furnace is an RTP-500V rapid annealing furnace produced by Beijing Dongzhixing Applied Physics Research Institute, and the vacuum equipment is a ZDF-5227 vacuum gauge produced by Chengdu Ruibao Electronic Technology Co., Ltd.

In the present invention, the first-stage vacuum degree of the first-stage diffusion heat treatment is preferably 0.55-0.60 Pa, further preferably 0.56-0.59 Pa, and more preferably 0.57-0.58 Pa; and the second-stage vacuum degree is preferably 1×10⁻⁵-1×10⁻⁴ Pa, further preferably 2×10⁻⁵-8×10⁻⁵ Pa, and more preferably 4×10⁻⁵-6×10⁻⁵ Pa.

In the present invention, the first-stage vacuum degree of the second-stage tempering heat treatment is preferably 0.55-0.60 Pa, further preferably 0.56-0.59 Pa, and more preferably 0.57-0.58 Pa; and the second-stage vacuum degree is preferably 1×10⁻⁵-1×10⁻⁴ Pa, further preferably 2×10⁻⁵-8×10⁻⁵ Pa, and more preferably 4×10⁻⁵-6×10⁻⁵ Pa.

In the present invention, the temperature of the first-stage diffusion heat treatment is preferably 500-950° C., further preferably 600-850° C., and more preferably 700-750° C.; and the time of the first-stage diffusion heat treatment is preferably 1-8 h, further preferably 2-7 h, and more preferably 4-5 h.

In the present invention, the temperature of the second-stage tempering heat treatment is preferably 400-550° C., further preferably 420-530° C., and more preferably 450-500° C.; and the time of the second-stage tempering heat treatment is preferably 1-2 h, further preferably 1.2-1.8 h, and more preferably 1.4-1.6 h.

The technical schemes provided by the present invention are described in detail below in combination with embodiments, but the embodiments should not be understood as limiting the protection scope of the present invention.

All neodymium iron boron magnets used in the embodiments of the present invention are prepared from an industrial production line, and the magnets are 40SH of the same batch and brand.

### Embodiment 1

1 mol of dysprosium chloride hexahydrate, 1 mol of copper sulfate pentahydrate, 1 mol of aluminum chloride, 3 mol of boric acid, 3 mol of glycine, 4 mol of citric acid, 4 mol of sodium citrate and 3 mol of sodium sulfate were added into water and stirred at a rotation speed of 200 r/min at 50° C. for 30 min to prepare a diffusion water-based solution (the molar concentration of dysprosium in the diffusion water-based solution was 5%), and the pH of the diffusion water-based solution was adjusted to 6 with a 1 mol/L NaOH solution; a neodymium iron boron magnet was sequentially subjected to polishing with 800-mesh abrasive paper, 1,500-mesh abrasive paper and 3,000-mesh abrasive paper; then, the diffusion water-based solution was evenly deposited on the surface of the neodymium iron boron substrate by a constant-current electrodeposition method, where the current was set to 5 mA, the time was 10 min, and the solution temperature was 50° C.; after completion of deposition, the magnet was taken out and rinsed with deionized water, then the surface was washed with anhydrous ethanol, and the magnet was sent to a vacuum drying box for drying at 0.10 Pa at 50° C. for 60 min; and after completion of the drying, a sample was subjected to first-stage diffusion heat treatment at 900° C. for 6 h (at a first-stage vacuum degree of 0.56 Pa and a second-stage vacuum degree of 5×10⁻⁴ Pa) and second-stage tempering heat treatment at 500° C. for 2 h (at a first-stage vacuum degree of 0.56 Pa and a second-stage vacuum degree of 5.5×10⁻⁴ Pa) to obtain a neodymium iron boron magnet with enhanced coercive force, which was recorded as a magnet 1.

When other conditions were controlled unchanged, a magnet 2 and a magnet 3 were obtained by setting the time of the first-stage diffusion heat treatment to 6.5 h and 5.5 h, respectively. Meanwhile, when other conditions were controlled unchanged, a magnet 4 was obtained by omitting the electrodeposition step. The magnets 1, 2, 3 and 4 were machined and sampled to obtain samples with a length of 14.5 mm and a width of 6.0 mm, and the coercive force and magnetic energy product of the samples were measured by a magnetic property measuring instrument, respectively. Results obtained are shown in Table 1.

TABLE 1
Comparison results of magnetic properties of various magnets

| | | Maximum magnetic | |
|---|---|---|---|
| | Coercive force | energy product | Residual |
| Sample | (kA/m) | (kJ/m³) | magnetism (T) |
| Magnet 1 | 1448 | 328 | 1.318 |
| Magnet 2 | 1393 | 334 | 1.333 |
| Magnet 3 | 1308 | 317 | 1.297 |
| Magnet 4 | 1127 | 324 | 1.308 |

As can be seen from Table 1, compared with the sintered neodymium iron boron magnet prepared by the same process without electrodeposition treatment, the sintered neodymium iron boron magnets obtained by electrochemical deposition and heavy rare earth grain boundary diffusion in the present invention have the advantages that the coercive force is improved, the coercive force of the diffusion magnets is increased by nearly 30%, and the residual magnetism and the maximum magnetic energy product are almost unchanged.

### Embodiment 2

1.2 mol of dysprosium chloride hexahydrate, 1.3 mol of copper sulfate pentahydrate, 1.2 mol of aluminum chloride, 3.1 mol of boric acid, 3.2 mol of glycine, 4.4 mol of citric acid, 4.3 mol of sodium citrate and 3.1 mol of sodium sulfate were added into water and stirred at a rotation speed of 230 r/min at 52° C. for 23 min to prepare a diffusion water-based solution (the molar concentration of dysprosium in the diffusion water-based solution was 5.3%), and the pH of the diffusion water-based solution was adjusted to 5.7 with a 1.1 mol/L NaOH solution; a neodymium iron boron magnet was sequentially subjected to polishing with 850-mesh abrasive paper, 1,550-mesh abrasive paper and 3,050-mesh abrasive paper; then, the diffusion water-based solution was evenly deposited on the surface of the neodymium iron boron substrate by a constant-current electrodeposition method, where the current was set to 6 mA, the time was 16 min, and the solution temperature was 52° C.; after completion of deposition, the magnet was taken out and rinsed with deionized water, then the surface was washed with anhydrous ethanol, and the magnet was sent to a vacuum drying box for drying at 0.30 Pa at 45° C. for 52 min; and after completion of the drying, a sample was subjected to first-stage diffusion heat treatment at 800° C. for 5 h (at a first-stage vacuum degree of 0.58 Pa and a second-stage vacuum degree of 7×10⁻⁴ Pa) and second-stage tempering heat treatment at 450° C. for 1.7 h (at a first-stage vacuum degree of 0.57 Pa and a second-stage vacuum degree of 7×10⁻⁴ Pa) to obtain a neodymium iron boron magnet with enhanced coercive force.

By using a measuring method same as that in Embodiment 1, the coercive force of the neodymium iron boron magnet obtained in the present embodiment was measured to be 1,399 kA/m, the maximum magnetic energy product was 330 kJ/m³, and the residual magnetism was 1.320 T.

### Embodiment 3

0.8 mol of terbium trichloride hexahydrate, 0.8 mol of copper sulfate pentahydrate, 0.9 mol of aluminum chloride, 2.7 mol of boric acid, 2.7 mol of glycine, 3.6 mol of citric acid, 3.7 mol of sodium citrate and 2.8 mol of sodium sulfate were added into water and stirred at a rotation speed of 220 r/min at 48° C. for 26 min to prepare a diffusion water-based solution (the molar concentration of terbium in the diffusion water-based solution was 4.7%), and the pH of the diffusion water-based solution was adjusted to 5.5 with a 0.9 mol/L NaOH solution; a neodymium iron boron magnet was sequentially subjected to polishing with 750-mesh abrasive paper, 1,450-mesh abrasive paper and 2,950-mesh abrasive paper; then, the diffusion water-based solution was evenly deposited on the surface of the neodymium iron boron substrate by a constant-current electrodeposition method, where the current was set to 8 mA, the time was 20 min, and the solution temperature was 48° C.; after completion of deposition, the magnet was taken out and rinsed with deionized water, then the surface was washed with anhydrous ethanol, and the magnet was sent to a vacuum drying box for drying at 0.25 Pa at 43° C. for 49 min; and after completion of the drying, a sample was subjected to first-stage diffusion heat treatment at 750° C. for 7 h (at a first-stage vacuum degree of 0.59 Pa and a second-stage vacuum degree of 2×10⁻⁴ Pa) and second-stage tempering heat treatment at 520° C. for 1.4 h (at a first-stage vacuum degree of 0.58 Pa and a second-stage vacuum degree of 3×10⁻⁴ Pa) to obtain a neodymium iron boron magnet with enhanced coercive force.

By using a measuring method same as that in Embodiment 1, the coercive force of the neodymium iron boron magnet obtained in the present embodiment was measured to be 1423 kA/m, the maximum magnetic energy product was 329 kJ/m³, and the residual magnetism was 1.316 T.

As can be seen from the above embodiments, after the grain boundary diffusion heat treatment of the present invention is performed, the coercive force of a magnet is effectively improved, and the residual magnetism of the magnet is almost unchanged. Tests have found that the coercive force of the magnet after diffusion is effectively increased by nearly 30%.

The present invention provides a treatment method for enhancing the coercive force of a neodymium iron boron magnet. A chloride salt of a heavy rare earth element Dy or Tb and a low-melting-point metal sulfate (such as Cu and Al) are fully and evenly mixed in a pure water-based solution under the cooperation between a complexing agent and a buffer to form a sapphire clear and transparent solution as a diffusion water-based solution. The heavy rare earth element in the diffusion source is evenly co-deposited on the surface of a neodymium iron boron magnet substrate with a polished bright surface in the form of a heavy rare earth/low-melting-point metal alloy by a constant-current electrodeposition method, and then first-stage diffusion heat treatment and second-stage tempering heat treatment are performed in an atmosphere at a high vacuum degree, so that the heavy rare earth element is diffused into the neodymium iron boron magnet in the form of gas phase/liquid phase free atoms and undergoes grain boundary diffusion. Meanwhile, low-melting-point metal components enter a grain boundary phase to lubricate the grain boundary phase, so as to enhance a demagnetizing coupling effect between main phase grains. According to the present invention, the coercive force of a sintered neodymium iron boron magnet is improved by improving the phase composition of a main phase of the magnet and optimizing the internal microstructure of the magnet.

The descriptions above are only preferred embodiments of the present invention. It should be noted that for persons of ordinary skill in the art, various improvements and modifications can be made without departing from the principles of the present invention, and all the improvements and modifications should also be regarded as falling within the protection scope of the present invention.

What is claimed is:

1. A treatment method for enhancing a coercive force of a neodymium iron boron magnet, comprising the following steps:
(1) subjecting the neodymium iron boron magnet to electrochemical deposition in a diffusion water-based solution to obtain a neodymium iron boron magnet containing a heavy rare earth;
(2) subjecting the neodymium iron boron magnet containing the heavy rare earth to a heat treatment to complete an enhancement of the coercive force of the neodymium iron boron magnet.

2. The treatment method of claim 1, wherein the diffusion water-based solution in step (1) comprises the following components: a chloride salt of the heavy rare earth, copper sulfate pentahydrate, aluminum chloride, boric acid, glycine, citric acid, sodium citrate, sodium sulfate, and water;
the chloride salt of the heavy rare earth is dysprosium chloride hexahydrate or terbium trichloride hexahydrate;
a molar ratio of the chloride salt of the heavy rare earth, the copper sulfate pentahydrate, the aluminum chloride, the boric acid, the glycine, the citric acid, the sodium citrate, and the sodium sulfate is (0.5-1.5):(0.5-1.5):(0.5-1.5):(2.5-3.5):(2.5-3.5):(3.5-4.5):(3.5-4.5):(2.5-3.5); and a molar concentration of the heavy rare earth in the diffusion water-based solution is 4-6%.

3. The treatment method of claim 2, wherein the diffusion water-based solution in step (1) has a pH value of 5-6; and the electrochemical deposition is at a current of 5-10 mA.

4. The treatment method of claim 3, wherein the electrochemical deposition in step (1) is at a solution temperature of 45-55° C.

5. The treatment method of claim 3, wherein the electrochemical deposition in step (1) is for 10-30 min.

6. The treatment method of claim 5, wherein the heat treatment in step (2) comprises a first-stage diffusion heat treatment and a second-stage tempering heat treatment performed sequentially;
the first-stage diffusion heat treatment is at a first-stage vacuum degree of 0.55-0.60 Pa and a second-stage vacuum degree of 1×10⁻⁵-1×10⁻⁴ Pa; and
the second-stage tempering heat treatment is performed at a first-stage vacuum degree of 0.55-0.60 Pa and a second-stage vacuum degree of 1×10⁻⁵-1×10⁻⁴ Pa.

7. The treatment method of claim 6, wherein the first-stage diffusion heat treatment is at a temperature of 500-950° C., and the first-stage diffusion heat treatment is for 1-8 h.

8. The treatment method of claim 7, wherein the second-stage tempering heat treatment is at a temperature of 400-550° C., and the second-stage tempering heat treatment is for 1-2 h.

9. The treatment method of claim 4, wherein the electrochemical deposition in step (1) is for 10-30 min.

10. The treatment method of claim 9, wherein the heat treatment in step (2) comprises a first-stage diffusion heat treatment and a second-stage tempering heat treatment performed sequentially;
the first-stage diffusion heat treatment is at a first-stage vacuum degree of 0.55-0.60 Pa and a second-stage vacuum degree of 1×10⁻⁵-1×10⁻⁴ Pa; and
the second-stage tempering heat treatment is performed at a first-stage vacuum degree of 0.55-0.60 Pa and a second-stage vacuum degree of 1×10⁻⁵-1×10⁻⁴ Pa.

11. The treatment method of claim 10, wherein the first-stage diffusion heat treatment is at a temperature of 500-950° C., and the first-stage diffusion heat treatment is for 1-8 h.

12. The treatment method of claim 11, wherein the second-stage tempering heat treatment is at a temperature of 400-550° C., and the second-stage tempering heat treatment is for 1-2 h.
